(19) United States
(12) Patent Application Publication
(10) Pub. No.: US 2016/0029441 A1
(43) Pub. Date: Jan. 28, 2016

(54) PREFERENTIALLY DIRECTING ELECTROMAGNETIC ENERGY TOWARDS COLDER REGIONS OF OBJECT BEING HEATED BY MICROWAVE OVEN

(71) Applicant: Janson Arthur TAYLOR, Kensington, MD (US)

(72) Inventors: Jason Arthur Taylor, Kensington, MD (US); Rebecca Zeltinger, Kensington, MD (US)

(21) Appl. No.: 14/773,837

(22) PCT Filed: Mar. 17, 2014
(86) PCT No.: PCT/US14/30402

§ 371 Date: Sep. 9, 2015

Related U.S. Application Data
(60) Provisional application No. 61/802,189, filed on Mar. 15, 2013.

(51) Int. Cl. H05B 6/64; H05B 6/66; H05B 6/68; H05B 6/80

(52) U.S. Cl. CPC H05B 6/6455; H05B 6/80; H05B 6/664; H05B 6/68

(57) ABSTRACT

Systems and/or techniques for preferentially directing electromagnetic energy towards colder regions of an object are provided. During at least a portion of a heat treatment via a microwave oven, temperature measurements of the object are acquired to identify colder regions of the object. Microwaves ovens often heat objects non-uniformly. For example, an outer surface of a burrito may be hot-to-touch while a center core of the burrito is still frozen.

### RELATED APPLICATIONS

This application claims priority to and benefit of PCT/US2014/30402; U.S. Provisional Patent Application Ser. No. 61/802,189, filed on Mar. 15, 2013; the 893-page document named “2a11-rejected by pto.pdf” and “2all.pdf” having a SHA1 hash of 7a271c60be78e0f42a1ad30d07fcdbdd2e5933b8 electronically delivered to the USPTO on Mar. 15, 2013 EDT generated from a file having a SHA1 hash of c0168e4b165192348a36b522f423e793455a45db; and the 433-page scanned document entitled “Specification” in the 61/802,189 IFW that is stamped “BEST COPY AVAILABLE” physically delivered to the USPTO Customer Service Window on Mar. 15, 2013 EST pursuant to the USPTO instructions; each herein incorporated by reference.

### BACKGROUND

Microwave ovens often heat objects non-uniformly. For example, an outer surface of a burrito may be hot-to-touch while a center core of the burrito is still frozen. As another example, a left-side of the burrito may be hot while the right-side is barely warm. One conventional solution to this problem has been to rotate the object while a heat treatment is performed in an attempt to more uniformly expose the object to electromagnetic energy.

U.S. Publication 2007/0007283, U.S. Pat. No. 7,514,658 and U.S. Pat. No. 4,553,011 describe technologies related to microwave ovens and are herein incorporated by reference.

### DESCRIPTION OF THE DRAWINGS

Aspects of the disclosure are understood from the following detailed description when read with the accompanying drawings. It will be appreciated that elements and structures of the drawings are not necessarily drawn to scale. Accordingly, the dimensions of the various features is arbitrarily increased or reduced for clarity of discussion.

FIG. 1 illustrates an example microwave oven.

FIG. 2 illustrates a component block diagram of an apparatus for preferentially directing electromagnetic energy towards colder regions of an object undergoing a heat treatment by a microwave oven.

FIG. 3 illustrates a flow diagram of an example method for preferentially directing electromagnetic energy towards colder regions of an object undergoing a heat treatment by a microwave oven.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

Microwave ovens use electromagnetic energy, or more particularly microwaves, to heat an object, such as food. Typically, a microwave oven projects the microwaves towards the object, causing water molecules in the object to vibrate. The vibration of the water molecules causes frictional heat to be generated between the water molecules, and the frictional heat warms the object.

When the microwaves are projected and/or reflected from the inner walls of a cooking chamber, traveling microwaves and reflected microwaves are superposed, and an electromagnetic field is formed within the microwave oven that exhibits strong and weak spots. Due to the inconsistent distribution of the electromagnetic field, the object is often heated non-uniformly. One technique to mitigate this non-uniformity is to move or rotate the object within the cooking chamber during a heat treatment. For example, the object may be placed on a turn-table and rotated within the cooking chamber. However, such an approach requires mechanical assemblies, which often consume a portion of the cooking chamber, and do not necessarily cause the object to be heated uniformly.

Accordingly, systems and/or techniques for preferentially directing electromagnetic energy towards colder regions of an object are provided. During at least a portion of a heat treatment via a microwave oven, temperature measurements of the object are acquired to identify colder regions of the object. A colder region refers to a region having a lower temperature than one or more neighboring regions, a region where the temperature is less than an average temperature of the object, and/or a region where the temperature is less than a desired temperature. For example, a left-side of the object may measure 45° C. while a right-side of the object measures 0° C. Accordingly, the right-side may be identified as a colder region because, in relation to the left-side of the object, the right-side of the object is 45° colder. As another example, a center core may be 15° less than an average temperature, which may qualify the center core as a cooler region.

In some embodiments, preferentially directing electromagnetic energy towards colder regions of the object comprises applying higher intensity electromagnetic energy (also referred to as electromagnetic radiation) to the colder regions than to warmer regions. In this way, water molecules comprised within the colder regions are vibrated more quickly than water molecules comprised within the warmer regions, causing the colder regions to heat-up more quickly. In this way, the temperature of the colder regions can be increased until the temperature of the object is substantially uniform and/or until other stopping criteria has been met (e.g., a time duration for the heating treatment has been met).

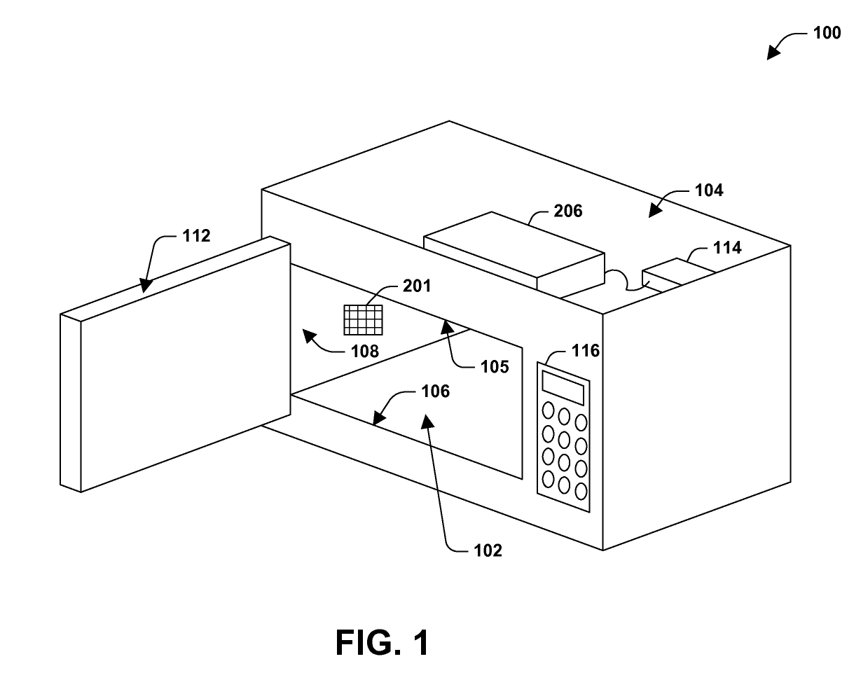

Referring to FIG. 1, an example microwave oven 100 is illustrated. The microwave oven 100 comprises a cooking chamber 102 for heating an object, such as a food, and an electric device enclosure 104 in which various electrical devices are installed.

The cooking chamber 102 is defined by an upper plate 105, a bottom plate 106, side plates 108, and a rear plate. A front side of the cooking chamber 102 is generally open to facilitate placing objects within the cooking chamber 102. During a heat treatment, the front side of the cooking chamber 102 may be covered to reduce exposure of the electromagnetic radiation to an environment outside the chamber. By way of example, in some embodiments, a door 112 is hinged to a body of the microwave oven 100 to selectively inhibit access to the cooking chamber 102 and/or to inhibit electromagnetic radiation from escaping the cooking chamber 102 through the front side.

As will be described in more detail below, the electric device enclosure 104 generally comprises a position sensitive heating apparatus 206 for supplying electromagnetic energy, such as microwaves or other high frequency waves, to the inside of the cooking chamber 102. In some embodiments, the electric device enclosure 104 further comprises, among other things, a power source 114 for supplying power to the position sensitive heating apparatus and/or a cooling fan for cooling the inside of the electric device enclosure 104. In some embodiments, the power source 114 is a high voltage transformer for applying high voltage to the position sensitive heating apparatus. The electric device enclosure 104 may also comprise a control panel 116 for controlling operation of the microwave oven 100 and/or for display an operation state of the microwave oven 100. By way of example, in some embodiments, the control panel 116 comprises a plurality of operation buttons which may be selected by a user to control various operations of the microwave oven.

In some embodiments, the electric device enclosure 104 further comprises a temperature detecting unit 201 for measuring temperatures of the object to identify colder regions of the object. In the illustrated embodiment, the temperature detecting unit 201 is mounted within a side plate 108. In other embodiments, the temperature detecting unit 201 is mounted within and/or adjacent to the upper plate 105, the bottom plate 106, side plates 108, and/or a rear plate, for example. Example temperature detecting units 201 include photodiodes, an infrared sensor arrays, and/or a charge-coupled devices (CCDs) or other temperature sensing elements. In some embodiments, a temperature sensing element is comprised of a plurality of pixels configured to measure a portion of the object. For example, respective pixels may be configured to measure a 1 mm area of the object.

In some applications, the temperature detecting unit 201 may comprise more than one temperature sensing element. For example, the temperature detecting unit 201 may comprise two or more infrared sensor arrays positioned at various locations within the microwave oven 100. The use of multiple sensing elements, positioned at various locations within the electric device enclosure 104 (e.g., a first temperature sensing element positioned proximate to or within the upper plate 105 and a second temperature sensing element positioned proximate to or within a side plate 108, two temperature sensing elements positioned at various locations proximate to or within the upper plate 105, etc.) may mitigate interference caused by food splatter, for example. By way of example, where readings from one or more pixels of a first temperature sensing element and corresponding to a first portion of the object are inaccurate due to food splatter on the pixels, readings from one or more pixels of a second temperature element and corresponding to the first portion of the object may be used to determine a temperature of the first portion of the object.

In some embodiments, the temperature detecting unit 201 further comprising a filter for selectively filtering optical wavelengths from non-optical wavelengths (e.g., such as infrared wavelengths). By way of example, a filter may be placed between the cooking chamber 102 and a charge-coupled device (CCD) of the temperature detecting unit 201 to inhibit optical wavelengths from interacting with the CCD.

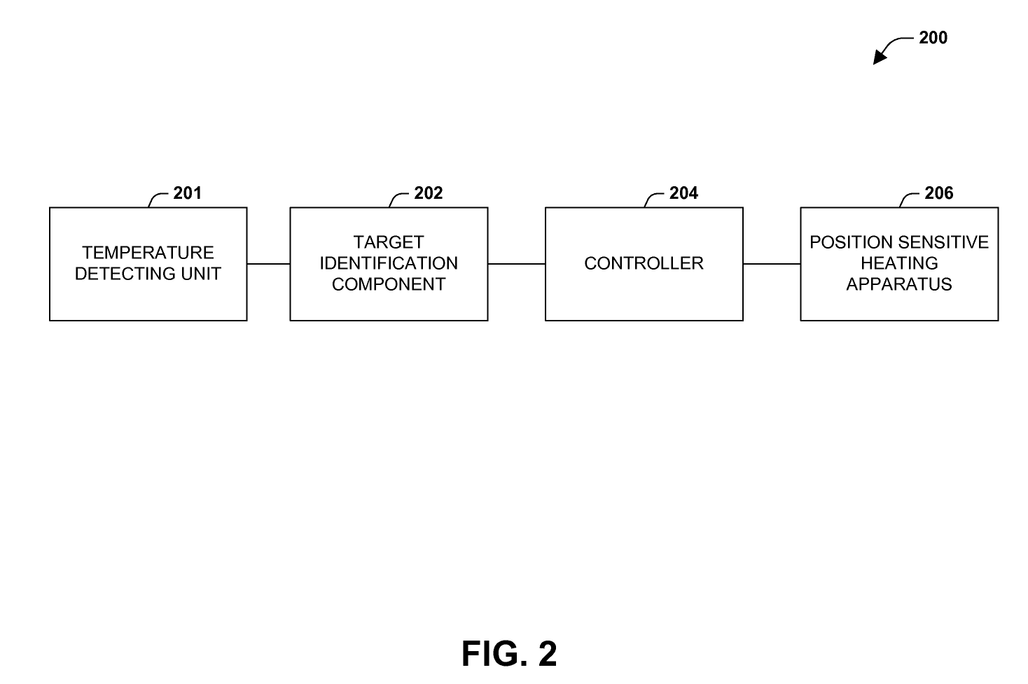

Referring to FIG. 2, a component block diagram further detailing an example apparatus 200 of a microwave oven configured to preferentially heat colder regions of an object is provided. Such components may be located within the electric device enclosure 104, for example.

The components include the temperature detecting unit 201, a target identification component 202, a controller 204, and the position sensitive heating apparatus 206.

The temperature detecting unit 201 measures the temperature at various points or regions of the object to generate temperature measurements and the target identification component 202 identifies colder regions of the object based upon the temperature measurements. By way of example, the target identification component 202 may develop a temperature profile of the object from the temperature measurements. Such a temperature profile may be one-dimensional, two-dimensional, and/or three-dimensional and may distinguish colder regions of the object from warmer regions of the object. By way of example, regions of the object that have a temperature which deviates from an average temperature by more than a specified threshold may be identified/distinguished as colder regions. As another example, regions of the object that have a temperature that deviates from the temperature of one or more neighboring regions by a specified deviation may be identified/distinguished as colder regions. In still other examples, other criteria may be used to identify colder regions and/or to define a colder region in relation to other regions.

The target identification component 202 is also configured to determine a spatial relationship between the colder regions and the position sensitive heating apparatus 206. The spatial relationship may describe an angular distance between the colder regions and a focal spot of the position sensitive heating apparatus 206 and/or may otherwise describe an orientation of the colder regions in relation to the position sensitive heating apparatus 206. As will be described in more detail below, determining the spatial relationship between the colder regions and the position sensitive heating apparatus 206 may facilitate determining how to direct electromagnetic energy towards the colder region and/or when to increase an intensity of the electromagnetic energy (e.g., to apply higher intensity electromagnetic energy to the colder regions).

In some applications, it may be desirable for the object to move and/or rotate within the cooking chamber 102. In such embodiments the microwave oven 100 may further comprise a rotation correlation component (not shown) for correlating the temperature profile with a rotation of the object to develop a correlation profile. By way of example, a temperature profile developed while the object was at a first orientation relative to temperature detecting unit 201 may not accurately represent the object when the object is rotated to a second orientation relative to the temperature detecting unit 201. In some embodiments, to avoid recalculating the temperature profile at respective orientations, for example, a temperature profile is developed while the object is at a first orientation and the rotation correlation component continually or intermittently correlates the temperature profile with a rotation of the object to develop the correlation profile, which relates the temperature profile to the object at any given point in time.

The controller 204 controls preferential application of the electromagnetic energy towards the colder regions. More particularly, the controller 204 uses the temperature profile and/or the correlation profile to determine which regions electromagnetic energy is preferentially directed toward. In this way, the controller 204 uses the temperature profile and/or the correlation profile to, at times, control a dosage of electromagnetic energy respective regions of the object are exposed to, where, at times, a higher dosage of electromagnetic energy may be applied to the colder regions than warmer regions.

In some embodiments, the controller 204 varies the intensity of electromagnetic energy output by the position sensitive heating apparatus 206 to preferentially direct electromagnetic energy towards the colder region. By way of example, the controller 204 may cause a higher voltage to be applied to the position sensitive heating apparatus 206 (e.g., increasing the intensity of the electromagnetic radiation) when the colder region is spatial proximate the position sensitive heating apparatus 206 and/or is within a beam path of electromagnetic radiation emitted by the position sensitive heating apparatus 206. At times when the colder region is not spatially proximate the position sensitive heating apparatus 206 and/or within the beam path, the controller 204 may cause a lower voltage to be applied to the position sensitive heating apparatus 206 to reduce exposure of electromagnetic radiation to warmer regions of the object, for example.

In other embodiments, the controller 204 varies the intensity distribution of the electromagnetic energy (e.g., shifting a direction of the beam path). By way of example, the controller 204 may vary the intensity distribution to cause electromagnetic radiation to target the colder regions.

The position sensitive heating apparatus 206 comprises one or more magnetrons, which are controlled by the controller 204, and, at times, preferentially direct electromagnetic radiation towards the colder regions. In some embodiments, a magnetron emits electromagnetic radiation along a substantially fixed path and the object is configured to rotate relative to the magnetron. In such embodiments, at times when the colder regions of the object are not spatially coincident with the beam path, the controller 204 may cause the magnetron to output electromagnetic radiation at a first intensity (e.g., a low intensity). At other times, when the colder regions of the object are spatially coincident with the beam path, the controller 204 may cause the magnetron to output electromagnetic radiation at a second intensity (e.g., a higher intensity). In this way, by varying the intensity of the radiation, a higher dosage of electromagnetic radiation is applied to the colder regions than to warmer regions, for example.

In some embodiments, the position sensitive heating apparatus 206 comprises at least two fixed-beam magnetrons (e.g., such as a first magnetron positioned near an upper plate 105 of the cooking chamber 102 and a second magnetron positioned near a side plate 108 of the cooking chamber 102), which may be independently controlled by the controller 204. By way of example, the controller 204 may cause a first magnetron to increase the intensity of electromagnetic energy output therefrom when the colder regions are proximate the first magnetron and/or may cause the second magnetron to increase the intensity of electromagnetic energy output therefrom when the colder regions are proximate the second magnetron. In embodiments where the object is configured to rotate, it may be appreciated that at some instances in time, the first magnetron may apply electromagnetic energy to the colder portions and, at other instances in the time, the second magnetron may apply electromagnetic energy to the colder portions. Accordingly, at times when the first magnetron is emitting electromagnetic energy toward the colder portions, the controller 204 may cause the first magnetron to increase the intensity of the output and at other times when the second magnetron is emitting electromagnetic energy toward the colder portions, the controller 204 may cause the second magnetron to increase the intensity of the output. In this way, by varying the intensity of the electromagnetic radiation output by respective magnetrons, a higher dosage of electromagnetic radiation is applied to the colder regions than to warmer regions, for example.

In still other embodiments, the position sensitive heating apparatus 206 comprises a phased array magnetron, such as described in “Phased Array Technology with Phase and Amplitude Controlled Magnetron for Microwave Power Transmission” by Naoki Shinohara and Hiroshi Matsumoto and found in the Proceedings of The 4th International Conference on Solar Power from Space—SPS '04. In such embodiments, the controller 204 may be configured to control the direction of a beam path through which electromagnetic radiation emitted by the phased array magnetron travels and/or may be configured to control the intensity of such electromagnetic radiation. By way of example, the controller 204 can adjust an intensity distribution of the phased array to cause the beam path to spatially coincide with the colder regions and/or to cause enhanced heating in the colder regions.

In some embodiments, where the object is configured to rotate, controller 204 may cause the phased array magnetron to move the beam path to spatially coincide with the colder regions for a portion of the rotation (e.g., causing the beam path to rotate substantially synchronously with the colder regions).

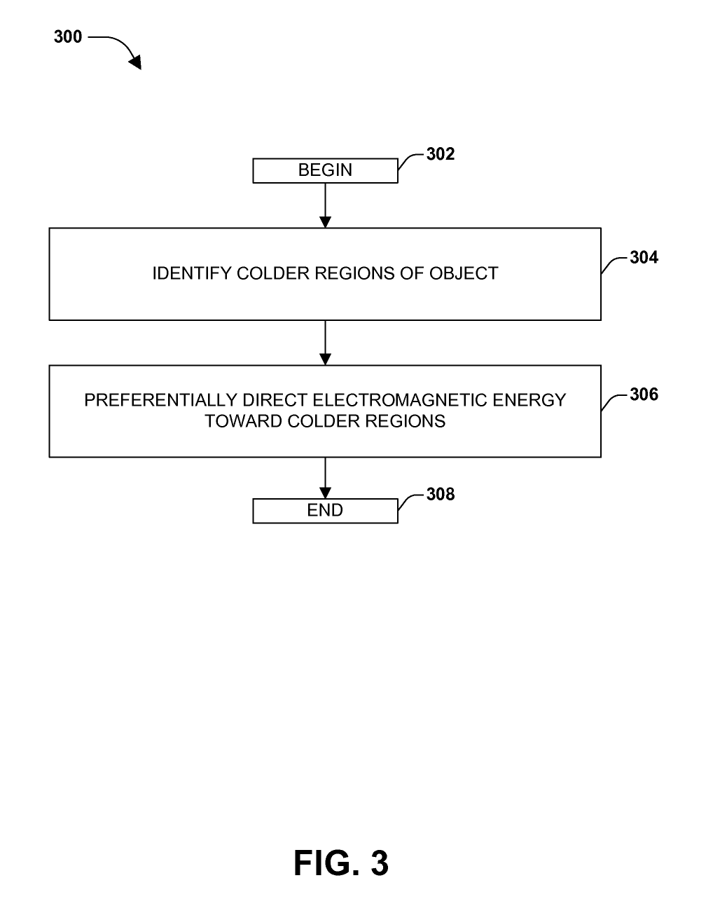

FIG. 3 illustrates a flow diagram of an example method 300 for preferentially directing electromagnetic energy towards colder regions of an object undergoing a heat treatment in a microwave oven. The method 300 begins at 302, and colder regions of the object are identified at 304. By way of example, temperature measurements indicative of various aspects of the object may be acquired from a temperature detecting device and the measurements may be analyzed to identify the colder regions. Various criteria may be used to define colder regions. In some embodiments, the colder regions are defined in relation to other regions of the object. For example, colder regions may be defined as regions of the object having a temperature that is less than an average temperature of the object by a specified threshold. As another example, colder regions may be defined as regions of the object having a temperature which deviates from a neighboring region(s) by more than a specified threshold. In other embodiments, colder regions are defined in terms of absolute values. By way of example, a user may be cooking a piece of meat and may specify a minimum temperature for the meat of 160° F. Regions of the meat that have a temperature of less than 160° F. may be identified as colder regions because such regions have not yet been heated to the minimum temperature. Moreover, as illustrated in the foregoing examples, the criteria used for defining colder regions may be user inputted and/or may be programmed into a controller at the time of manufacturing, for example.

In some embodiments, the acquisition of the temperature measurements may facilitate the generation of a temperature profile, such as a 1D, 2D, or 3D temperature profile. The profile may describe where the colder regions are located within the object and/or may describe a spatial relationship between the colder regions and the cooking chamber 102 and/or the position sensitive heating apparatus 206 (e.g., such as an angular distance between the position sensitive heating apparatus 206 and the colder regions). Moreover, as described with respect to FIG. 2, the profile may be utilized by a controller 204 to determine how to preferentially apply electromagnetic energy to the object (e.g., to bring the temperature of the colder regions more closely in-line with the temperature of the warmer regions).

At 306 in the example method 300, electromagnetic energy is preferentially directed toward the colder regions. In this way, a dosage of electromagnetic energy that is applied to the colder regions is increased relative to a dosage applied to the warmer regions (e.g., to cause the rate of temperature change at the colder regions to be higher than a rate of temperature change at the warmer regions and/or to reduce a difference in temperature between the colder regions and warmer regions).

As described with respect to FIG. 2, various techniques are contemplated for preferentially directing electromagnetic energy toward the colder regions. By way of example, in some embodiments, the intensity of electromagnetic radiation output by the position sensitive heating apparatus (e.g., the magnetron) is varied to output higher intensity electromagnetic radiation when the colder regions are located within a beam path of the electromagnetic radiation and/or to output higher intensity electromagnetic radiation at magnetrons located proximate the colder region. At times when the colder regions are not located within the beam path (e.g., due to the rotation of the object), the intensity of the electromagnetic radiation may be reduced to lessen the dosage of electromagnetic radiation applied to the warmer regions. In still other embodiments, the intensity distribution is adjusted to adjust a beam path of the electromagnetic radiation (e.g., to cause the beam path to intersect the colder regions.

It is to be appreciated that the example method 300 may be utilized during merely portions of the heating treatment or may be utilized for a duration of a heat treatment. By way of example, suppose a user wishes to heat a frozen burrito. For the first minute of the heat treatment, electromagnetic radiation may be applied using conventional methods (e.g., where the electromagnetic radiation is not preferentially applied to the colder regions). At the 1 minute mark, a temperature detecting unit may measure the temperature of various aspects of the burrito to identify colder regions of the burrito (e.g., which require extra heating). If colder regions are identified, electromagnetic energy may be preferentially applied towards the colder regions until stopping criteria has been satisfied (e.g., the colder regions reach a temperature that is within tolerance of the warmer regions, a time allotted for the heating treatment has lapsed, etc.).

The example method 300 ends at 308.

Although the subject matter has been described in language specific to structural features and/or methodological acts, it is to be understood that the subject matter of the appended claims is not necessarily limited to the specific features or acts described above. Rather, the specific features and acts described above are disclosed as example forms of implementing the claims.

Various operations of embodiments are provided herein. The order in which some or all of the operations are described should not be construed as to imply that these operations are necessarily order-dependent. Alternative ordering will be appreciated by one skilled in the art having the benefit of this description. Further, it will be understood that not all operations are necessarily present in each embodiment provided herein.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or identical channels or the same channel.

It will be appreciated that layers, features, elements, etc. depicted herein are illustrated with particular dimensions relative to one another, such as structural dimensions and/or orientations, for example, for purposes of simplicity and ease of understanding and that actual dimensions of the same differ substantially from that illustrated herein, in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes,” “having,” “has,” “with,” or variants thereof are used in either the detailed description or the claims, such terms are intended to be inclusive in a manner similar to the term “comprising.”

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims.

1. A microwave oven, comprising:
a position sensitive heating apparatus for preferentially directing electromagnetic energy towards colder regions of an object.

2. The microwave oven of claim 1, comprising a controller for varying an intensity of the electromagnetic energy output by the position sensitive heating apparatus.

3. (canceled)

4. The microwave oven of claim 1, wherein the position sensitive heating apparatus comprising two or more magnetrons.

5. The microwave oven of claim 4, wherein a first magnetron of the two or more magnetron positioned proximate a first surface of the microwave oven and a second magnetron of the two or more magnetrons positioned proximate a second surface of the microwave oven.

6. The microwave oven of claim 1, wherein the position sensitive heating apparatus comprises a phased array magnetron.

7. The microwave oven of claim 6, comprising a controller for adjusting an intensity distribution of the phased array to cause enhanced heating in the colder regions.

8. The microwave oven of claim 1, comprising a target identification component for determining a spatial relationship between the position sensitive heating apparatus and the colder regions.

9. The microwave oven of claim 9, wherein the position sensitive heating apparatus emits electromagnetic energy along a substantially fixed beam path and the spatial relationship defines an angular relationship between the fixed beam path and the colder regions.

10. The microwave oven of claim 1, comprising a temperature detecting unit.

11. The microwave oven of claim 10, wherein the temperature detecting unit comprises a photodiode.

12. (canceled)

13. The microwave oven of claim 10, wherein the temperature detecting unit comprises a charge-coupled device (CCD).

14. The microwave oven of claim 10, wherein the temperature detecting unit comprises a filter for selectively filtering optical wavelengths from non-optical wavelengths.

15. The microwave oven of claim 10, comprising a target identification component for developing a temperature profile of the object from temperature measurements yielded from the temperature detecting unit.

16. (canceled)

17. (canceled)

18. The microwave oven of claim 15, wherein the temperature profile is a three-dimensional temperature profile.

19. The microwave oven of claim 15, comprising a rotation correlation component for correlating the temperature profile with a rotation of the object to develop a correlation profile.

20. The microwave oven of claim 19, the position sensitive heating apparatus configured to utilize the correlation profile to preferentially direct electromagnetic energy towards colder regions.

21. (canceled)

22. A method preferentially directing electromagnetic energy towards colder regions of an object, comprising:
identifying the colder regions of the object undergoing a heat treatment in a microwave oven; and
preferentially directing the electromagnetic energy towards the colder regions.

23. The method of claim 22, wherein identifying the colder regions comprises:
developing a temperature profile of the object.

24. The method of claim 22, wherein preferentially directing the electromagnetic energy towards the colder region comprises:
increasing an intensity of the electromagnetic energy applied to the colder regions.

25. The method of claim 24, wherein increasing the intensity of the electromagnetic energy applied to the colder regions comprises at least one of:
adjusting a voltage applied to a magnetron emitting the electromagnetic energy when the colder regions are within a beam path of the electromagnetic radiation to increase the intensity of electromagnetic energy at times when the colder regions are within the beam path, or
adjusting an orientation of the beam path to increase the intensity of the electromagnetic energy applied to the colder regions.
